(19) United States
(12) Patent Application Publication
(10) Pub. No.: US 2021/0073651 A1
(43) Pub. Date: Mar. 11, 2021

(54) MODEL GENERATING METHOD AND MODEL GENERATING APPARATUS

(71) Applicant: Tokyo Electron Limited, Tokyo (JP)

(72) Inventors: Toshihiro KITAO, Austin, TX (US); Haruki OMINE, Hokkaido (JP)

(21) Appl. No.: 17/010,000

(22) Filed: Sep. 2, 2020

(30) Foreign Application Priority Data
Sep. 11, 2019 (JP) 2019-165662

(51) Int. Cl. G06N 3/12

(52) U.S. Cl. CPC G06N 3/126

(57) ABSTRACT

A model generating method performed by a computer is provided. First, multiple models are generated by repeatedly executing genetic programming that receives a training data set as an input, and for each of the multiple models, a fitness value that represents a degree of conformity between a corresponding model of the multiple models and the training data set is generated. Next, an indicator is calculated for each of the multiple models, and the multiple models are classified into clusters, by using the indicator calculated for each of the multiple models. Next, a cluster to which the largest number of the models belong is selected from the clusters. Finally, from among models belonging to the selected cluster, a model with the greatest fitness value is selected.

### CROSS-REFERENCE TO RELATED APPLICATIONS

This patent application is based on and claims priority to Japanese Patent Application No. 2019-165662 filed on Sep. 11, 2019, the entire contents of which are incorporated herein by reference.

### TECHNICAL FIELD

The present disclosure relates to a model generating method, a model generating apparatus, and a program.

### BACKGROUND

Genetic programming (GP) has been known. In genetic programming, by providing a combination of input data and output data as training data, a model (e.g., a function) that fits the training data can be obtained as an output result. Meanwhile, because genetic programming is an algorithm that uses random numbers, a resulting model may significantly differ from those previously modelled, even if the same training data is given. Thus, in a case in which input data is given to a model obtained at a current time, its output may differ significantly from an output obtained from a model that was previously modelled. Thus, in genetic programming, reproducibility of a modelling result is low, and genetic programming may not be practical.

Patent Document 1 describes a technique in which a calculation time of an optimization process using genetic programming until an optimum solution is obtained can be shortened.

### RELATED ART DOCUMENT

### Patent Document

[Patent Document 1] Japanese Laid-open Patent Application Publication No. 2017-162069

### SUMMARY

The present disclosure provides a model generating method, a model generating apparatus, and a program having high reproducibility of model generation, in the modeling using genetic programming.

In one aspect of the present disclosure, a model generating method performed by a computer is provided. First, multiple models are generated by repeatedly executing genetic programming that receives a training data set as an input, and for each of the multiple models, a fitness value that represents a degree of conformity between a corresponding model of the multiple models and the training data set is generated. Next, an indicator is calculated for each of the multiple models, and the multiple models are classified into clusters, by using the indicator calculated for each of the multiple models. Next, a cluster to which the largest number of the models belong is selected from the clusters. Finally, from among models belonging to the selected cluster, a model with the greatest fitness value is selected.

### BRIEF DESCRIPTION OF THE DRAWINGS

FIG. 1 is a diagram illustrating an example of the overall configuration of a model generating apparatus;

FIG. 2 is a diagram illustrating an example of the hardware configuration of the model generating apparatus;

FIG. 3 is a flowchart illustrating an example of a model generating process;

FIG. 4 is a view for explaining an example of setting a threshold and clustering using a dendrogram;

FIG. 5 is a view for explaining a case in which multiple largest clusters are present;

FIG. 6 is a diagram illustrating an example of a semiconductor manufacturing system; and

FIG. 7 is a flowchart illustrating a semiconductor manufacturing apparatus controlling process in a second embodiment.

### DETAILED DESCRIPTION OF EMBODIMENTS

Hereinafter, embodiments will be described with reference to the drawings. For substantially the same components in the present specification and drawings, overlapping descriptions are omitted by giving the same reference numerals.

As noted above, in genetic programming, by providing training data, a model that fits the training data can be obtained as an output. However, in genetic programming, resulting models generally differ for each execution of genetic programming. Further, for example, differences between models cannot be evaluated as errors, and these models may be evaluated as completely different models. Thus, genetic programming may be less reproducible for modeling.

Accordingly, in the present embodiment, a model generating apparatus 10 capable of generating models with high reproducibility, by using genetic programming, will be described. Accordingly, by using the model generating apparatus 10 to be described in the present embodiment, models can be stably obtained with high reproducibility. In the present embodiment, a model is a program (or a program module) or data for predicting output data from input data, and a model is represented by, for example, a mathematical expression such as a function or a formula. Thus, the model generating apparatus 10 according to the present embodiment is applicable to generation of a model that is a solution of a regression problem or the like.

### First Embodiment

<Overall Configuration of Model Generating Apparatus 10>

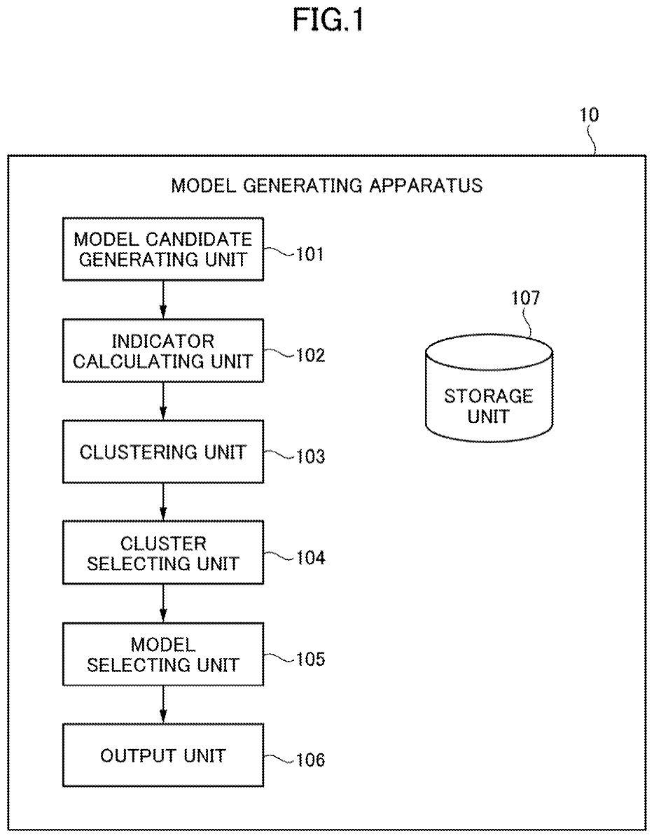

First, the overall configuration of the model generating apparatus 10 will be described. FIG. 1 is a diagram illustrating an example of the overall configuration of the model generating apparatus 10.

As illustrated in FIG. 1, the model generating apparatus 10 includes a model candidate generating unit 101, an indicator calculating unit 102, a clustering unit 103, a cluster selecting unit 104, a model selecting unit 105, an output unit 106, and a storage unit 107.

The storage unit 107 stores various data necessary for generating a model (for example, a set of training data used for inputs of genetic programming, or the like). Hereinafter, a set of training data used for inputs of genetic programming may also be referred to as a “training data set”.

The model candidate generating unit 101 performs genetic programming multiple times by using the training data set stored in the storage unit 107 as an input, to obtain multiple models as the outputs of genetic programming. Hereinafter, the models obtained by the model candidate generating unit 101 may also be referred to as “model candidates”. Each of the model candidates is stored in the storage unit 107 in association with fitness, for example.

The fitness (may also be referred to as a fitness value) is a value used to select a model (e.g., a mathematical expression such as a function or a formula) in genetic programming, which represents a degree of conformity between a model and a training data set. In genetic programming, an ultimately selected model is output as a result. In the present embodiment, a model that is output as an output result of the genetic programming is referred to as the model candidate.

As indicator for evaluating similarity among model candidates stored in the storage unit 107, the indicator calculating unit 102 calculates sensitivity of each of the model candidates. Here, the sensitivity is an example of the indicator, and the sensitivity represents magnitude of variation in output data of a model candidate with respect to variation in input data. The sensitivity may be expressed by a scalar, or may be expressed by a vector. Regarding model candidates being of close sensitivity, variation in output data with respect to variation in input data tends to be similar. Thus, these model candidates can be said to be similar to each other. Sensitivity calculated by the indicator calculating unit 102 is stored in the storage unit 107 in association with a model candidate used for calculating the sensitivity, for example.

The clustering unit 103 divides (classifies) model candidates into multiple clusters by using sensitivity of each of the model candidates that is calculated by the indicator calculating unit 102. When classifying model candidates, the clustering unit 103 classifies the model candidates into multiple clusters so as to maximize a distance between the clusters. This results in similar model candidates (and identical model candidates) belonging to the same cluster. Hereinafter, in model candidates that are similar to each other, identical model candidates may be included.

The cluster selecting unit 104 selects a cluster having the largest number of elements (e.g., model candidates) from among the clusters classified by the clustering unit 103. That is, the cluster selecting unit 104 selects the cluster to which the largest number of model candidates belong. Here, because the number of elements in a cluster corresponds to the number of model candidates similar to each other, the larger the number of elements in a cluster, the more likely it is for identical or similar model candidates to be generated when generating model candidates by genetic programming. That is, the greater number of elements in a cluster, the more reproducible the model candidate belonging to the cluster.

The model selecting unit 105 selects a model candidate having the maximum fitness in genetic programming, from among the cluster selected by the cluster selecting unit 104 (hereafter, a cluster selected by the cluster selecting unit 104 may also be referred to as the “largest cluster”).

The output unit 106 outputs the model candidate selected by the model selecting unit 105 as an ultimately generated model. This provides a highly reproducible model in genetic programming.

An output destination of the output unit 106 may be any destination. For example, the output unit 106 may output (store) a model to the storage unit 107, output (transmit) a model to other devices connected via a communication network, or output (display) a model to a display device or the like.

### <Hardware Configuration of Model Generating Apparatus 10>

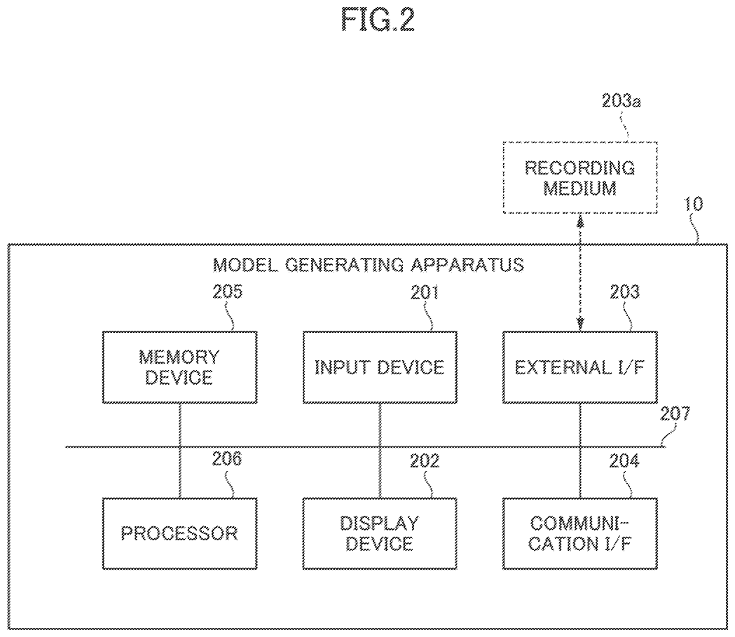

Next, the hardware configuration of the model generating apparatus 10 will be described. FIG. 2 is a diagram illustrating an example of the hardware configuration of the model generating apparatus 10.

As illustrated in FIG. 2, the model generating apparatus 10 includes an input device 201, a display device 202, an external interface (I/F) 203, a communication I/F 204, a memory device 205, and a processor 206. Each of these hardware components is interconnected via a bus 207. A so-called computer is formed by at least the memory device 205 and the processor 206.

The input device 201 may be, for example, a keyboard, a mouse, a touch panel, various operation buttons, or the like. The display device 202 may be, for example, a display or the like. The model generating apparatus 10 may not include at least either the input device 201 or the display device 202.

The external I/F 203 is an interface with an external device such as a recording medium 203a. Examples of the recording medium 203a include a floppy disk, a compact disc (CD), a digital versatile disc (DVD), an SD memory card, and a USB memory (or USB flash drive).

The communication I/F 204 is an interface for connecting the model generating apparatus 10 to the communication network.

The memory device 205 may be of various types of storage device, such as a random access memory (RAM), a read only memory (ROM), a flash memory, a hard disk drive (HDD), and a solid state drive (SSD). For example, the storage unit 107 may be implemented by using the memory device 205.

The processor 206 may be of various types of processing device, such as a central processing unit (CPU). The model candidate generating unit 101, the indicator calculating unit 102, the clustering unit 103, the cluster selecting unit 104, the model selecting unit 105, and the output unit 106 are realized, for example, by one or more computer programs stored in the memory device 205 being executed by the processor 206. The whole or a part of the one or more programs realizing the model candidate generating unit 101, the indicator calculating unit 102, the clustering unit 103, the cluster selecting unit 104, the model selecting unit 105, and the output unit 106 may be acquired (downloaded) from, for example, a server device connected via the communication I/F 204, or may be acquired (read) from the recording medium 203a via the external I/F 203.

The model generating apparatus 10 has the hardware configuration illustrated in FIG. 2, and various processes described below can be realized. However, the hardware configuration illustrated in FIG. 2 is an example, and the model generating apparatus 10 may take other hardware configurations. For example, the model generating apparatus 10 may include multiple memory devices 205, or may include multiple processors 206.

### <Model Generating Process>

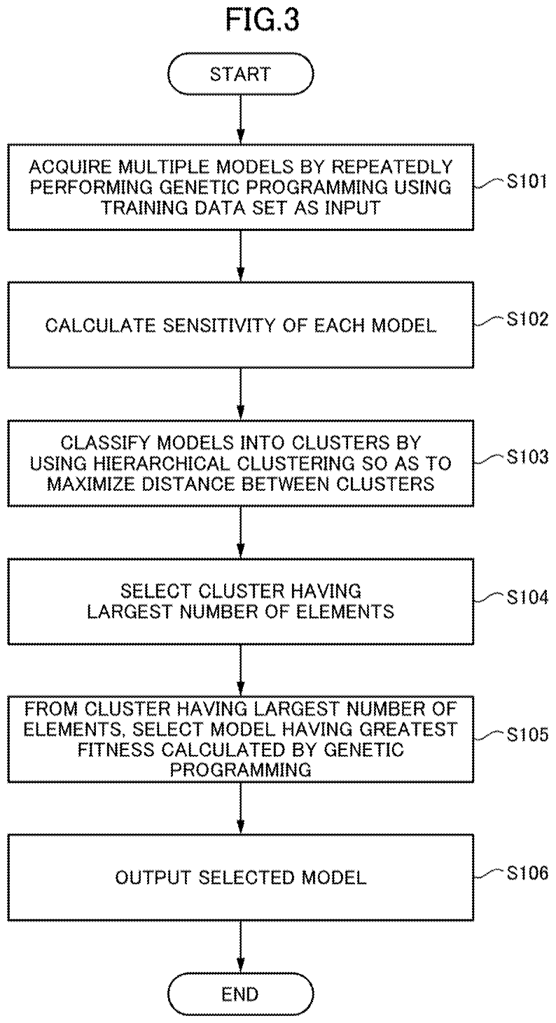

Next, a model generating process for generating models based on genetic programming with high reproducibility, which is performed by the model generating apparatus 10, will be described. FIG. 3 is a flowchart illustrating an example of the model generating process. In the following description, let the model candidate generated by genetic programming be a function f expressed by y=f(x₁, . . . , xₙ), where x₁, . . . , xₙ are the input data, and y is the output data. Examples of a model expressed by such a function f include a model in which n sensor values x₁, . . . , xₙ obtained from n respective sensors (various sensors such as a temperature sensor and a pressure sensor provided in a semiconductor manufacturing apparatus) for monitoring processing statuses are used to output a quality value y (for example, a CD (Critical Dimension) value representing a width of an opening of a hole or recess formed in the semiconductor wafer) of a certain processing result.

Let the training data set stored in the storage unit 107 be D, and D is expressed by the following expression (1).

D={d⁽ⁱ⁾:=(y⁽ⁱ⁾,x₁⁽ⁱ⁾, . . . ,xₙ⁽ⁱ⁾);i=1, . . . ,m} (1)

where d⁽ⁱ⁾ is i-th training data, and m is the number of training data included in the training data set D. Hereinafter, y⁽ⁱ⁾ included in training data d⁽ⁱ⁾ may also be referred to as “correct answer output data”, and x₁⁽ⁱ⁾, . . . , xₙ⁽ⁱ⁾ may also be referred to as “input data for training”.

First, in step S101, the model candidate generating unit 101 executes known genetic programming multiple times, by using the training data set D stored in the storage unit 107 as an input, to acquire multiple model candidates. The multiple model candidates are stored in the storage unit 107 in association with, for example, respective fitness of the model candidates. Thus, for example, if genetic programming is performed N times using the training data set D as the input, N model candidates and respective fitness of these N model candidates can be obtained. The number of times performing genetic programming may be designated by a user or the like, or may be predetermined.

In step S102, following step S101, for each of the model candidates stored in the storage unit 107, the indicator calculating unit 102 calculates the sensitivity. The sensitivity calculated for each of the model candidates is stored in the storage unit 107 in association with, for example, a corresponding model candidate used for calculating the sensitivity.

Here, the sensitivity of a model candidate (function f) can be calculated based on partial regression coefficients (or standardized partial regression coefficients) of the multiple regression equation y=f(x₁, . . . , xₙ), where x₁, . . . , and xₙ are explanatory variables and y is a target variable. For example, a change amount of the target variable y when the explanatory variable xⱼ (j=1, . . . , n) varies by Δxⱼ, is denoted by sⱼ. The sensitivity may be calculated as a sum of sⱼ (e.g., s₁+s₂ . . . +sₙ), or may be calculated by normalizing the sum of sⱼ. The indicator calculating unit 102 may compute the sⱼ (that is, a scalar quantity), as described above. Alternatively, as the sensitivity, the indicator calculating unit 102 may compute a vector having s₁ to sₙ as elements (=(s₁, s₂, . . . , sₙ)).

The above-noted Δxⱼ may be determined without constraint. For example, in a case in which sensitivity is calculated based on standardized partial regression coefficients, a standard deviation of the explanatory variable xⱼ in the training data set may be used as Δxⱼ. In this case, sⱼ can be said to be a change amount of the target variable y when the explanatory variable xⱼ varies by the standard deviation.

In step S103, following step S102, the clustering unit 103 classifies the model candidates into multiple clusters, by using the sensitivity calculated by the indicator calculating unit 102. At this time, the clustering unit 103 classifies the model candidates so as to maximize a distance between clusters.

Note that in the following description, a method for classifying the model candidates into clusters may also be referred to as a clustering method. As the clustering method, any type of method may be used. In the present embodiment, as an example of the clustering method, a hierarchical clustering using Ward's method will be described. The clustering unit 103 can classify the model candidates into multiple clusters, by performing hierarchical clustering using Ward's method according to the following steps 2-1 to 2-4.

(Step 2-1) First, the clustering unit 103 defines an initial state, in which each model candidate belongs to a different cluster. That is, for example, if there are L model candidates, the clustering unit 103 defines, as the initial state, a state in which there are L clusters each including only one model candidate different from those belonging to other clusters. Hereinafter, a cluster is denoted by Cₖ. “k” is an index (suffix) of the cluster, and in the initial state, k=1, . . . , L. In the initial state, L clusters (C₁, C₂, . . . , C_{L}) are defined.

(Step 2-2) Next, the clustering unit 103 combines (two) clusters closest to each other to form a new cluster. In Ward's method, a distance between clusters (may also be referred to as an “inter-cluster distance”) between the cluster Cₖ and the cluster C_{k′} is calculated by the following equation:

d_{c}(Cₖ,C_{k′})=E(CₖUC_{k′})−E(Cₖ)−E(C_{k′})

where d_{c} is the distance between clusters.

Note that E(Cₖ) is the sum of squares of the distance between the centroid of the cluster Cₖ(i.e., the average of sensitivity for all model candidates belonging to the cluster Cₖ) and the sensitivity corresponding to each model candidate belonging to the cluster Cₖ (this distance is also referred to as an “inter-sample distance”). Similarly, E(CₖUC_{k′}) is the sum of the inter-sample distances between the centroid of the cluster CₖUC_{k′}, which is the union of the cluster Cₖ and the cluster C_{k′}, and the sensitivity corresponding to each of the model candidates belonging to the cluster Cₖ or the cluster C_{k′}. In calculating the inter-sample distance, any type of distance can be used as the inter-sample distance. For example, Euclidean distance, Mahalanobis distance, Manhattan distance, Chebyshev distance, distance based on Cosine similarity, distance based on Tanimoto coefficient, and the like can be used as the inter-sample distance.

(Step 2-3) Next, the clustering unit 103 determines whether the number of clusters is one (i.e., only one cluster is present). If it is determined that the number of clusters is not one (that is, the number of clusters is two or more), the process of the clustering unit 103 returns to the above-described step 2-2. Accordingly, the above-described step 2-2 is executed repeatedly until the number of clusters becomes one. Meanwhile, if it is determined that only one cluster is present, the process of the clustering unit 103 proceeds to subsequent step 2-4.

When the number of clusters becomes one, the relationship between each of the model candidates and the clusters can be represented as a tree diagram called a dendrogram.

(Step 2-4) The clustering unit 103 adopts a clustering result in which the maximum inter-cluster distance d_{c} is obtained in step 2-2 as the final clustering result. At this time, the clustering unit 103 determines a threshold value Th for selecting the final clustering result, in order to obtain the final clustering result having the maximum inter-cluster distance d_{c} (i.e., the clustering arrangement selected from among all clustering arrangements, in which a pair of clusters having the greatest inter-cluster distance is present).

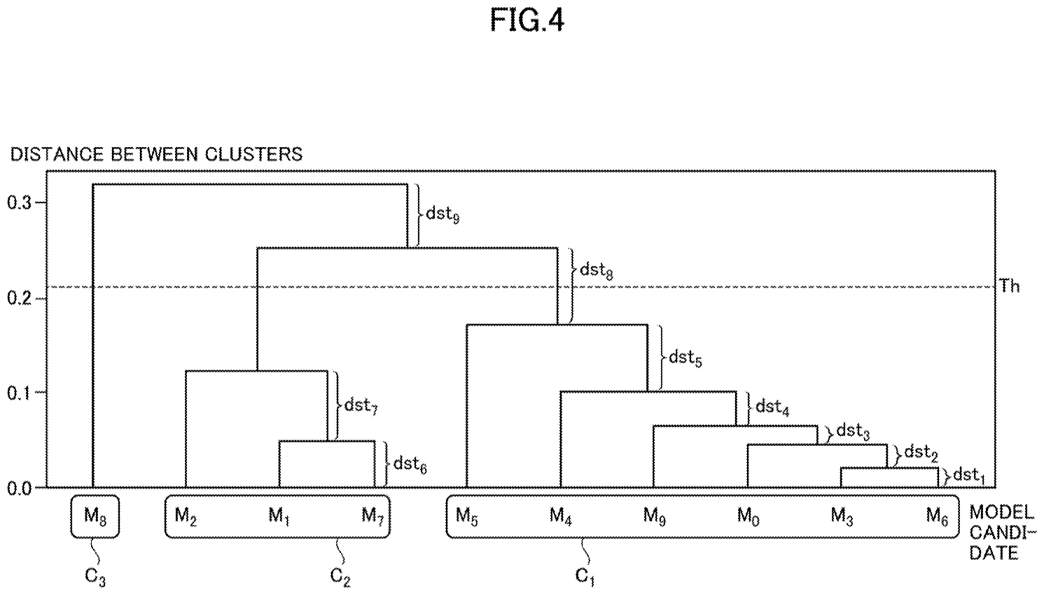

For example, suppose a case in which the dendrogram illustrated in FIG. 4 was obtained when 10 model candidates from M₀ to M₉ were subjected to a hierarchical clustering by Ward's method. In FIG. 4, the model candidates are placed on the horizontal axis, and the vertical axis indicates the inter-cluster distance. Definitions of dst₁ through dst₉ in FIG. 4 are as follows.

dst₁: inter-cluster distance between a cluster including the model candidate M₃ and a cluster including the model candidate M₆

dst₂: inter-cluster distance between a cluster including the model candidate M₀ and a cluster including the model candidates M₃ and M₆

dst₃: inter-cluster distance between a cluster including the model candidate M₉ and a cluster including the model candidates M₀, M₃, and M₆

dst₄: inter-cluster distance between a cluster including the model candidate M₄ and a cluster including the model candidates M₀, M₃, M₆, and M₉

dst₅: inter-cluster distance between a cluster including the model candidate M₁ and a cluster including the model candidates M₀, M₃, M₄, M₆, and M₄

dst₆: inter-cluster distance between a cluster including the model candidate M₁ and a cluster including the model candidate M₇

dst₇: inter-cluster distance between a cluster including the model candidate M₂ and a cluster including the model candidates M₁ and M₇

dst₈: inter-cluster distance between a cluster including the model candidates M₁, M₂, and M₇ and a cluster including the model candidates M₀, M₃, M₄, M₅, M₆, and M₉

dst₉: inter-cluster distance between a cluster including the model candidate M₈ and a cluster including the model candidates M₀, M₁, M₂, M₃, M₄, M₅, M₆, M₇, and M₉

Also, suppose a case of dst₃<dst₁<dst₂<dst₄<dst₅<dst₆<dst₇<dst₉<dst₈. In this case, the clustering unit 103 may determine a threshold value Th, for example, such that dst₉<Th<dst₈, and may perform clustering based on an inter-cluster distance exceeding this threshold value Th. Specifically, in the example illustrated in FIG. 4, the model candidates are classified into the cluster C₁ including the model candidates Mₖ, M₃, M₄, M₅, M₆, and M₉, the cluster C₂ including the model candidates M₁, M₂, and M₇, and the cluster C₃ including the model candidate M₈.

By classifying the model candidates into clusters so as to maximize the inter-cluster distance d_{c} (i.e., such that the largest inter-cluster distance can be obtained) as described above, even if the sensitivity is expressed as a vector for example, it is possible to obtain a stable clustering result against variations in the dimension of the vector.

In the present embodiment, the inter-cluster distance is calculated in accordance with Ward's method, but a calculation method of the inter-cluster distance is not limited thereto. For example, an inter-cluster distance may be calculated in accordance with a group average method, a shortest distance method, a longest distance method, or the like. Also, in the present embodiment, model candidates are classified into clusters by using the hierarchical clustering, but a clustering method is not limited thereto. Model candidates may be classified by using any clustering method (e.g., k-means clustering and the like). However, when the k-means clustering or the like is used, various parameters such as the above-described threshold value Th and the number of clusters k are determined by the user.

Following step S103, in step S104, the cluster selecting unit 104 selects the largest cluster (i.e., the cluster having the largest number of model candidates) from among the clusters obtained by the clustering unit 103.

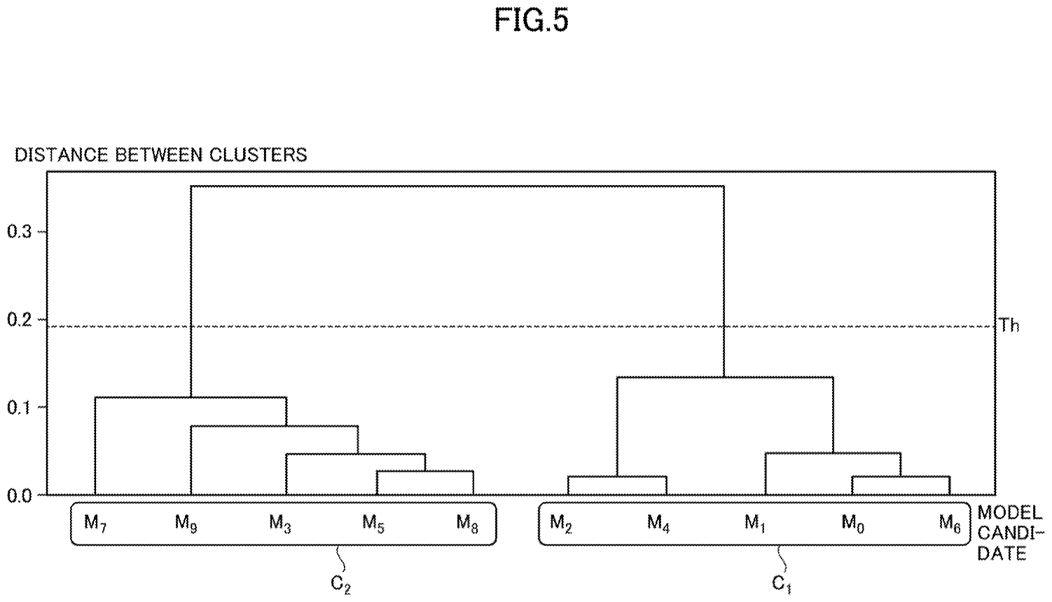

Here, as illustrated in FIG. 5, there may occur a case in which multiple clusters with the largest number of elements (i.e., model candidates) are present. In the example illustrated in FIG. 5, both the cluster C₁ and the cluster C₂ have “5” elements (model candidates), and the cluster C₁ and the cluster C₂ are both the largest clusters. In such a case, the cluster selecting unit 104 may, for example, select a cluster including a model candidate having the largest fitness, from among the largest clusters. In another embodiment, for example, from among the largest clusters, the cluster selecting unit 104 may select a cluster having model candidates whose average of fitness is the largest.

Following step S104, in step S105, the model selecting unit 105 selects the model candidate having the largest fitness from the largest cluster selected by the cluster selecting unit 104.

Finally, in step S106, the output unit 106 outputs the model candidate selected by the model selecting unit 105 as an ultimately generated model. According to the above-described method in the present embodiment, a model can be obtained with high reproductivity in genetic programming. Because a model obtained in the present embodiment is highly reproducible and has high fitness as described above, it is expected that predicting ability (that is, generalization performance) with respect to unknown input data is high.

### Second Embodiment

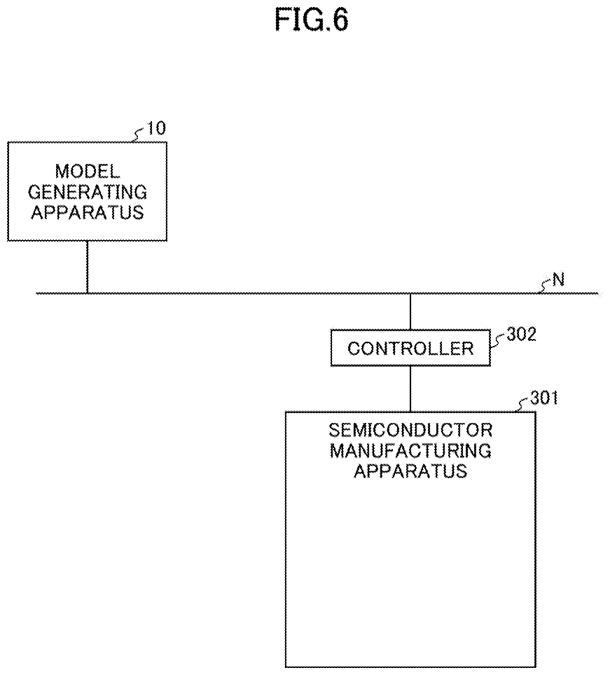

Next, examples of application of the above-described model generating apparatus 10 will be described. In the second embodiment, a case in which the above-described model generating apparatus 10 is applied to semiconductor manufacturing processing will be described. FIG. 6 is a diagram illustrating an example of a semiconductor manufacturing system.

The semiconductor manufacturing system illustrated in FIG. 6 includes the model generating apparatus 10, a semiconductor manufacturing apparatus 301, and a controller 302. As the configuration and function of the model generating apparatus 10 is the same as that in the first embodiment, detailed description of the model generating apparatus 10 is omitted.

The semiconductor manufacturing apparatus 301 is, for example, an etching apparatus that etches semiconductor substrates (may also be referred to as “wafers”). However, the semiconductor manufacturing apparatus 301 is not limited to an etching apparatus.

When etching a substrate, the substrate is loaded into a chamber of the semiconductor manufacturing apparatus 301, and an etching process is applied to the substrate in the chamber, under a certain process condition set by the controller 302.

The controller 302 is connected to the semiconductor manufacturing apparatus 301. The controller 302 controls each component of the semiconductor manufacturing apparatus 301. For example, the controller 302 may be configured by a general-purpose computer. When an etching process is applied to a substrate in the semiconductor manufacturing apparatus 301, the controller 302 controls the components of the semiconductor manufacturing apparatus 301 in order to control process conditions in the chamber. Examples of the process conditions include, but not limited to, a temperature in the chamber, a flow rate of a process gas supplied to the chamber during etching, an etching time (a period of time for etching a substrate in the chamber), and the like.

The controller 302 is also connected to the model generating apparatus 10 via a network N such as a local area network (LAN). In the example illustrated in FIG. 6, the model generating apparatus 10 is capable of controlling the semiconductor manufacturing apparatus 301 by issuing instructions to the controller 302. For example, the model generating apparatus 10 can control process conditions of a process performed in the chamber of the model generating apparatus 10 during etching. For example, by sending, from the model generating apparatus 10 to the controller 302, information about the process condition, such as a desired temperature value and a desired flow rate of a process gas, the controller 302 controls the semiconductor manufacturing apparatus 301 to adjust the temperature in the chamber, the flow rate of the process gas, and the like.

Similar to the first embodiment, the model generated by the model generating apparatus 10 (model generating process) according to the second embodiment is a function f expressed by y=f(x₁, . . . , xₙ), where x₁, . . . , xₙ are the input data, and y is the output data. In the following, the model obtained by the model generating apparatus 10 according to the second embodiment is referred to as a “wafer process model”. The input data (x₁, . . . , xₙ) of the wafer process model is process conditions, such as a temperature in the chamber and a flow rate of a process gas supplied to the chamber during etching. Also, the output data (y) of the wafer process model is the CD value of a hole to be formed on a wafer by etching.

Similar to the first embodiment, the model generating apparatus 10 according to the second embodiment executes the model generating process (FIG. 3) described in the first embodiment to obtain the wafer process model (function f). Also, the model generating apparatus 10 according to the second embodiment also performs a process of controlling the semiconductor manufacturing apparatus 301 by using the obtained wafer process model. The process of controlling the semiconductor manufacturing apparatus 301 using the wafer process model is referred to as a “semiconductor manufacturing apparatus controlling process”. In addition to the program that causes the processor 206 to execute the above-described model generating process illustrated in FIG. 3, the model generating apparatus 10 also includes a program that causes the processor 206 to execute the semiconductor manufacturing apparatus controlling process (in the following description, this program is referred to as a “control program”). The control program may be stored in the storage unit 107, or may be downloaded from other computers via the network N.

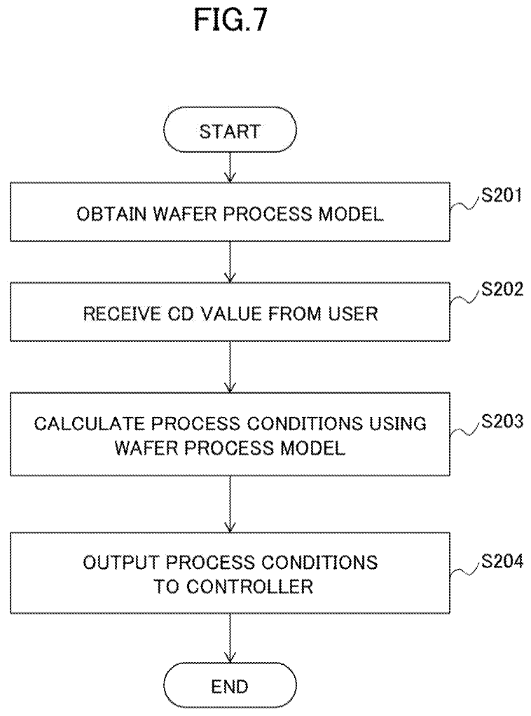

Details of the semiconductor manufacturing apparatus controlling process will be described with reference to FIG. 7. The semiconductor manufacturing apparatus controlling process is executed after the wafer process model is obtained by executing the model generating process. Because a process of generating the wafer process model (model generating process) in the second embodiment is similar to the model generating process in the first embodiment, description of the process is omitted.

The semiconductor manufacturing apparatus controlling process is executed by the processor 206 in the model generating apparatus 10. First, the processor 206 obtains the wafer process model generated by the model generating process (step S201). The processor 206 may obtain the wafer process model by reading out the wafer process model from the storage unit 107, after the model generating process (output unit 106) outputs (stores) the wafer process model into the storage unit 107.

Next, by using the input device 201, an operator of the model generating apparatus 10 (hereinafter referred to as a “user”) inputs the CD value of a hole that the user desires to form on a wafer by etching, and the processor 206 receives the CD value entered by the user (step S202). As described above, the CD value corresponds to the output data of the wafer process model. That is, the process of step S202 is equivalent to a process of receiving the output data of the wafer process model. In the following, the output data (CD value) received from the user is denoted by y′.

Next, in step S203, the processor 206 calculates the input data corresponding to the output data (y′) received in step S203, by using the wafer process model (function f). Specifically, the processor 206 calculates (searches for) the input data (x₁, . . . , xₙ) that satisfies “f(x₁, . . . , xₙ)−y′=0”. Alternatively, the processor 206 may calculate (search for) the input data (x₁, . . . , xₙ) that minimizes (f(x₁, . . . , xₙ)−y′)². In order to search for the input data (x₁, . . . , xₙ) satisfying “f(x₁, . . . , xₙ)−y′=0” (or minimizing (f(x₁, . . . , xₙ)−y′)²), conventional methods for solving an optimization problem may be used. For example, a gradient method, such as Newton's method or quasi-Newton method, may be used. In a case in which a gradient method is used, initial values of the input data is required. As the initial values of the input data, arbitrary value may be used. Alternatively, the initial values of the input data may be selected from the training data set used by the model generating process.

As described above, the input data (x₁, . . . , xₙ) is the process conditions, such as a temperature in the chamber and a flow rate of a process gas supplied to the chamber. Thus, by performing step S203, the process conditions (x₁, . . . , xₙ), which are required for forming a hole having the CD value y′ on the wafer by etching, can be obtained.

After the input data (x₁, . . . , xₙ) is calculated in step S203, the processor 206 outputs (sends) the input data (process conditions) to the controller 302 to control the semiconductor manufacturing apparatus 301 (step S204). By outputting the input data (process conditions) to the controller 302, the controller 302 adjusts the process conditions (e.g., temperature, flow rate of process gas) in the semiconductor manufacturing apparatus 301 based on the input data.

As described above, when the model generating apparatus 10 according to the second embodiment receives the output data (CD value) y′ from the user, the model generating apparatus 10 outputs the process conditions (input data x₁, . . . , xₙ) that satisfies f(x₁, . . . , xₙ)−y′=0 (or outputs the input data (x₁, . . . , xₙ) that minimizes (f(x₁, . . . , xₙ)−y′)²). In other words, when the user desires to form a hole on a wafer by etching, by only inputting the CD value (output data y′) of the hole that the user desires to form on the wafer, the model generating apparatus 10 can output the process conditions that are required for forming the hole having the CD value y′, by using the wafer process model, and the model generating apparatus 10 can control the semiconductor manufacturing apparatus 301 based on the output process conditions. Therefore, in the semiconductor manufacturing system according to the second embodiment, the user can process the wafer at a desired etching profile without requiring extensive experience in wafer processing.

In another embodiment, the model generating apparatus 10 (semiconductor manufacturing apparatus controlling process) may obtain process conditions (input data) using multiple wafer process models. An example will be described below.

In this case, the model generating process of the model generating apparatus 10 generates multiple models (wafer process models). For example, when a wafer on which multiple layers of films are formed is to be etched and when the user desires to predict CD values of the first to s-th (s is an integer greater than 1) layers of the films, the user may cause the model generating apparatus 10 (model generating process) to generate the wafer process models that calculate CD values of the respective layers (CD value of the first layer, CD value of the second layer, . . . , and CD value of the s-th layer). In the following description, the CD value of the first layer, the CD value of the second layer, . . . , and the CD value of the s-th layer may be referred to as y₁, y₂, . . . , and yₛ, respectively. Also, the wafer process models that calculates y₁, y₂, . . . , and yₙ are denoted by f₁(x₁, . . . , xₙ), f₂(x₁, . . . , xₙ), . . . , and fₙ(x₁, . . . , xₙ), respectively. Note that the input data (x₁, . . . , xₙ) is the process conditions.

The flow of the semiconductor manufacturing apparatus controlling process in this case will be described with reference to FIG. 7. First, in step S201, the processor 206 obtains the wafer process models (f₁, f₂, . . . , f₃) generated by the model generating process. Next, by using the input device 201, the user inputs desired CD values of the respective layers (i.e., CD values that the user desires to realize), and the processor 206 receives the CD value entered by the user (step S202). In the following, the CD values (output data) received in step S202 are denoted by y₁′, y₂′, . . . , and yₙ′.

Next, in step S203, the processor 206 calculates the input data corresponding to the CD values (output data (y₁′, . . . , yₛ′)) received in step S203, by using the wafer process models (f₁, f₂, . . . , fₛ). For example, the processor 206 may calculate (search for) the input data (x₁, . . . , xₙ) that minimizes a sum of squares of differences between y_{k′} (k=1, 2, . . . , s) and fₖ(x₁, . . . , xₙ). That is, the processor 206 may search for the input data (x₁, . . . , xₙ) that minimizes the following expression:

$${\sum }_{k = 1}^{s} {( {f}_{k} ( {x}_{1} , {x}_{2} , … , {x}_{n} ) - {y}_{k}^{′} )}^{2} .$$

After the input data (x₁, . . . , xₙ) is calculated in step S203, step S204 is executed. The process performed in step S204 is similar to that described in the second embodiment.

Note that the method of calculating the input data performed in step S203 is not limited to the method of searching for the input data (x₁, . . . , xₙ) that minimizes the sum of squares of the differences between yₖ′ and fₖ(x₁, . . . , xₙ). For example, input data that minimizes a sum of absolute values of the differences between yₓ′ and fₖ(x₁, . . . , xₙ) (i.e., Σ|fₖ(x₁, x₂, . . . , xₙ)−yₖ′|) may be calculated. In other words, in order to obtain process conditions (input data (x₁, . . . , xₙ)) in step S203, the semiconductor manufacturing apparatus controlling process (processor 206) may use any mathematical function that evaluates the dissimilarity between the vector (f₁(x₁, . . . , xₙ), f₂(x₁, . . . , xₙ), . . . , fₙ(x₁, . . . , xₙ)) and the vector (y₁′, y₂′, . . . , yₛ′).

### Third Embodiment

Next, the third embodiment will be described. Similar to the second embodiment, the third embodiment describes a case in which the above-described model generating apparatus 10 is applied to semiconductor manufacturing processing performed in a semiconductor manufacturing system. As the configuration of the semiconductor manufacturing system in the third embodiment is the same as that in the second embodiment, description of the semiconductor manufacturing system will be omitted.

Similar to the second embodiment, the model generating apparatus 10 according to the third embodiment performs the model generating process described in the first or second embodiment to generate (output) a model, and calculates the process conditions by using the model. However, in the third embodiment, the model generating apparatus 10 generates a model in which the input data is information about an etching profile of a hole and the like that is to be formed in a substrate (wafer), and in which the output data is the process condition such as a temperature in the chamber or a flow rate of a process gas supplied to the chamber. In the third embodiment, the model generated by the model generating apparatus 10 is denoted by y=g(x₁, . . . , xₙ), where g is a name of a function, x₁, . . . , xₙ are input data of the model, and y is output data of the model. As described above, the input data is information about an etching profile of a hole and the like that is to be formed in a wafer. In the following description, information about an etching profile may also be referred to as “etching profile information”. Examples of the etching profile information include a depth of a hole and the like formed by etching, and a CD value of an opening of the hole and the like. Also, the output data is a process condition during etching of a wafer, such as a temperature in the chamber or an etching time. Thus, the training data set that is used in the example is a set of combinations of etching profile information and a process condition.

In addition to the above-described model generating process, the model generating apparatus 10 according to the third embodiment also performs a process of calculating the output data (i.e., process condition) from the input data (i.e. etching profile information) by using the model (function g) that is obtained by performing the model generating process. In the following description, the process of calculating the output data (i.e., process condition) from the input data (i.e. etching profile information) by using the model (function g) is referred to as a “process condition calculating process”. The process condition calculating process is implemented by software (program). The program implementing the process condition calculating process is referred to as a “calculation program”. The calculation program may be stored in the storage unit 107, or may be downloaded from other computers via the network N.

Details of the process condition calculating process will be described. The process condition calculating process is executed after the model (function g) is obtained by executing the model generating process.

First, the processor 206 obtains the model. This step is similar to step S201 in the second embodiment. After the processor 206 obtains the model, the user inputs the input data (etching profile information) by using the input device 201. When the processor 206 receives the input data (etching profile information) from the user, the processor 206 calculates the output data y (process condition) by using the model. Specifically, the processor 206 substitutes the input data to the function g to calculate the output data.

After the output data (process condition) is calculated, the model generating apparatus 10 outputs the output data (process condition) to the controller 302. For example, if a flow rate of a process gas is calculated as the process condition, the model generating apparatus 10 generates an instruction including the calculated flow rate, and send the instruction to the controller 302 to control the flow rate of the process gas to be at the calculated flow rate. When the controller 302 receives the instruction from the model generating apparatus 10, the controller 302 controls the semiconductor manufacturing apparatus 301 based on the instruction.

As described above, the model generating apparatus 10 according to the third embodiment can obtain (calculate) the process condition by using the model generated by the model generating process, similar to the second embodiment. The model generating apparatus 10 according to the third embodiment differs from the second embodiment in that the model generating apparatus 10 according to the third embodiment generates a model in which the input data is the etching profile information and the output data is the process condition. Thus, in the third embodiment, the process condition can be calculated quickly by substituting the input data (etching profile information) to the model (function g).

The semiconductor manufacturing system described in the second or third embodiment is a mere example, and may take other configurations. For example, the model generating apparatus 10 and the controller 302 may be implemented by a single computer.

It should be noted that the present invention is not limited to the above-described embodiments specifically disclosed. Variations and modifications of the structure described in the above-described embodiments, combinations with other components, and the like may be made without departing from the spirit of the present invention.

What is claimed is:

1. A method performed by a computer, the method comprising:
generating a plurality of models by repeatedly executing genetic programming that receives a training data set as an input;
generating, for each of the plurality of models, a fitness value that represents a degree of conformity between a corresponding model of the plurality of models and the training data set;
calculating an indicator for each of the plurality of models;
classifying the plurality of models into a plurality of clusters, by using the indicator calculated for each of the plurality of models;
selecting, from the clusters, a cluster to which a largest number of the models belong; and
selecting, from models belonging to the selected cluster, a model with a greatest fitness value.

2. The method according to claim 1, wherein
the indicator represents magnitude of variation in output data with respect to variation in input data of a corresponding model; and
the indicator is expressed by a scalar quantity or a vector.

3. The method according to claim 1, wherein
in the classifying of the plurality of models, the plurality of models are classified into the plurality of clusters so as to maximize a distance between the plurality of clusters, by using a predetermined clustering method.

4. The method according to claim 3, wherein the predetermined clustering method is Ward's method, a group average method, a shortest distance method, or a longest distance method.

5. The method according to claim 1, wherein each of the models is expressed by a function that receives sensor values acquired from one or more sensors as input data, and that outputs a quality value of an object to be inspected.

6. A model generating apparatus comprising:
a processor; and
a memory storing a computer program that causes the processor to perform processes including
generating a plurality of models by repeatedly executing genetic programming that receives a training data set as an input;
generating, for each of the plurality of models, a fitness value that represents a degree of conformity between a corresponding model of the plurality of models and the training data set;
calculating an indicator for each of the plurality of models;
classifying the plurality of models into a plurality of clusters, by using the indicator calculated for each of the plurality of models;
selecting, from the clusters, a cluster to which a largest number of the models belong; and
selecting, from models belonging to the selected cluster, a model with a greatest fitness value.

7. The model generating apparatus according to claim 6, wherein
the indicator represents magnitude of variation in output data with respect to variation in input data of a corresponding model; and
the indicator is expressed by a scalar quantity or a vector.

8. The model generating apparatus according to claim 6, wherein
in the classifying of the plurality of models, the plurality of models are classified into the plurality of clusters so as to maximize a distance between the plurality of clusters, by using a predetermined clustering method.

9. The model generating apparatus according to claim 8, wherein the predetermined clustering method is Ward's method, a group average method, a shortest distance method, or a longest distance method.

10. The model generating apparatus according to claim 6, wherein each of the models is expressed by a function that receives sensor values acquired from one or more sensors as input data, and that outputs a quality value of an object to be inspected.

11. A non-transitory computer-readable recording medium storing a computer program that causes a processor in a computer to perform a method, the method comprising:
generating a plurality of models by repeatedly executing genetic programming that receives a training data set as an input;
generating, for each of the plurality of models, a fitness value that represents a degree of conformity between a corresponding model of the plurality of models and the training data set;
calculating an indicator for each of the plurality of models;
classifying the plurality of models into a plurality of clusters, by using the indicator calculated for each of the plurality of models;
selecting, from the clusters, a cluster to which a largest number of the models belong; and
selecting, from models belonging to the selected cluster, a model with a greatest fitness value.

12. The non-transitory computer-readable recording medium according to claim 11, wherein
the indicator represents magnitude of variation in output data with respect to variation in input data of a corresponding model; and
the indicator is expressed by a scalar quantity or a vector.

13. The non-transitory computer-readable recording medium according to claim 11, wherein
in the classifying of the plurality of models, the plurality of models are classified into the plurality of clusters so as to maximize a distance between the plurality of clusters, by using a predetermined clustering method.

14. The non-transitory computer-readable recording medium according to claim 13, wherein the predetermined clustering method is Ward's method, a group average method, a shortest distance method, or a longest distance method.

15. The non-transitory computer-readable recording medium according to claim 11, wherein each of the models is expressed by a function that receives sensor values acquired from one or more sensors as input data, and that outputs a quality value of an object to be inspected.
